(19) United States
(12) Patent Application Publication
(10) Pub. No.: US 2025/0012897 A1
(43) Pub. Date: Jan. 9, 2025

(54) SYSTEMS AND APPARATUSES FOR A PROTECTIVE MODULE FOR ROBOTIC SENSORS

(71) Applicant: Brain Corporation, San Diego, CA (US)

(72) Inventor: Jeremiah Cox, San Diego, CA (US)

(21) Appl. No.: 18/893,360

(22) Filed: Sep. 23, 2024

Related U.S. Application Data
(63) Continuation of application No. PCT/US23/17043, filed on Mar. 31, 2023.
(60) Provisional application No. 63/326,202, filed on Mar. 31, 2022.

(51) Int. Cl. G01S 7/481; G01S 17/931

(52) U.S. Cl. CPC G01S 7/4813; G01S 17/931

(57) ABSTRACT

Systems and apparatuses for a protective module for robotic sensors is disclosed herein. According to at least one non-limiting exemplary embodiment, the module includes rows of misaligned teeth which (i) enable sufficient return signal to acquire measurements of targets, and (ii) occlude a portion of the sensor lens to prevent hazards from contacting the lens. Advantageously, the protective module preserves operative capabilities of the robot and sensor while ensuring protection against expected hazards of an environment.

### PRIORITY

This application is a continuation of International Patent Application No. PCT/US23/17043 filed on Mar. 31, 2023 and claims the benefit of U.S. Provisional Patent Application Ser. No. 63/326,202 filed on Mar. 31, 2022 under 35 U.S.C. § 119, the entire disclosure of which is incorporated herein by reference.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### Technological Field

The present application relates generally to robotics, and more specifically to systems and apparatuses for a protective module or a device for robotic sensors.

### SUMMARY

The foregoing needs are satisfied by the present disclosure, which provides for, inter alia, systems and apparatuses for a protective module or device for robotic sensors.

Exemplary embodiments described herein have innovative features, no single one of which is indispensable or solely responsible for their desirable attributes. Without limiting the scope of the claims, some of the advantageous features will now be summarized. One skilled in the art would appreciate that as used herein, the term robot may generally refer to an autonomous vehicle or object that travels a route, executes a task, or otherwise moves automatically upon executing or processing computer readable instructions.

According to at least one non-limiting exemplary embodiment, a module for a robot to prevent collisions with hazards is disclosed. The module comprises a top portion comprising a first toothed edge comprising one or more top teeth; a bottom portion comprising a second toothed edge comprising one or more bottom teeth; wherein, the top and bottom portions surround a sensor of the robot; and the top teeth and the bottom teeth define a gap comprising a size wide enough to permit transmission and receipt of signals from the sensor to one or more objects of interest while being no larger than the hazard.

According to at least one non-limiting exemplary embodiment, the sensor is a light detection and ranging sensor configured to measure along a plane, and the teeth, at least in part, occlude a portion of a receiver element of the light detection and ranging sensor.

According to at least one non-limiting exemplary embodiment, the one or more teeth form spacings; and the teeth of the top portion protrude into the spacings of the top portion; and the teeth of the bottom portion protrude into the spacings of the top portion.

According to at least one non-limiting exemplary embodiment, the teeth of the top portion and bottom portion are of a size and shape configured to not occlude more than a threshold value of either (i) a reflected signal to the sensor from the object of interest, or (ii) a subtended area of a detector of the light detection and ranging sensor from the perspective of the object of interest.

According to at least one non-limiting exemplary embodiment the threshold is no larger than 20%.

According to at least one non-limiting exemplary embodiment, the occlusion caused by the teeth is uniform across the field of view of the light detection and ranging sensor. The uniform nature may be characterized by a uniform solid angle of the detector occluded by the teeth when the detector is viewed from an orthographic perspective. The uniform nature may also be characterized by a uniform return signal strength as a function of angle across the field of view.

According to at least one non-limiting exemplary embodiment, the protective module further comprises one or more attachment mechanisms within the connection interface configured to allow the module to be coupled to a robot without manipulation of the sensor.

According to at least one non-limiting exemplary embodiment, the protective module further comprises a connection interface capable of mechanically coupling the module to the robot.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a”, “an”, and “the” include plural referents unless the context clearly dictates otherwise.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A is a functional block diagram of a robot in accordance with some embodiments of this disclosure.

FIG. 1B is a functional block diagram of a controller or processor in accordance with some embodiments of this disclosure.

FIG. 2A(i-ii) illustrate a range sensor configured to measure distances within an environment and generate a plurality of points in accordance with some embodiments of this disclosure.

FIG. 2B(i) illustrates beam divergence due to, in part, atmospheric diffusion of a range sensor in accordance with some embodiments of this disclosure.

FIG. 2B(ii) illustrates a field of view of a range sensor in accordance with some embodiments of this disclosure.

FIG. 3A-D depicts a configuration process for coupling a new protective module to an existing robot, according to an exemplary embodiment.

FIG. 4A is a front facing view of a protective module placed over a sensor of a robot, according to an exemplary embodiment.

FIG. 4B is a side view of a protective module placed over a sensor of a robot, according to an exemplary embodiment.

FIG. 5A illustrates various parameters of the protective module which may be tuned to ensure returning signals from a range sensor include sufficient power, according to an exemplary embodiment.

FIG. 5B illustrates a side view of a protective module for a sensor and various configurable parameters thereof to ensure (i) outgoing signals are not obscured, (ii) hazards cannot reach the sensor, and (iii) sufficient return signal is achieved to receive measurement, according to an exemplary embodiment.

FIG. 6 is a process flow diagram illustrating a method for an operator to couple a protective module onto an existing robot, according to an exemplary embodiment.

FIG. 7 is a process flow diagram illustrating a method of configuring the various tunable parameters of a protective module for use on a robot to protect its sensor, according to an exemplary embodiment.

All Figures disclosed herein are @ Copyright 2023 Brain Corporation. All rights reserved.

### DETAILED DESCRIPTION

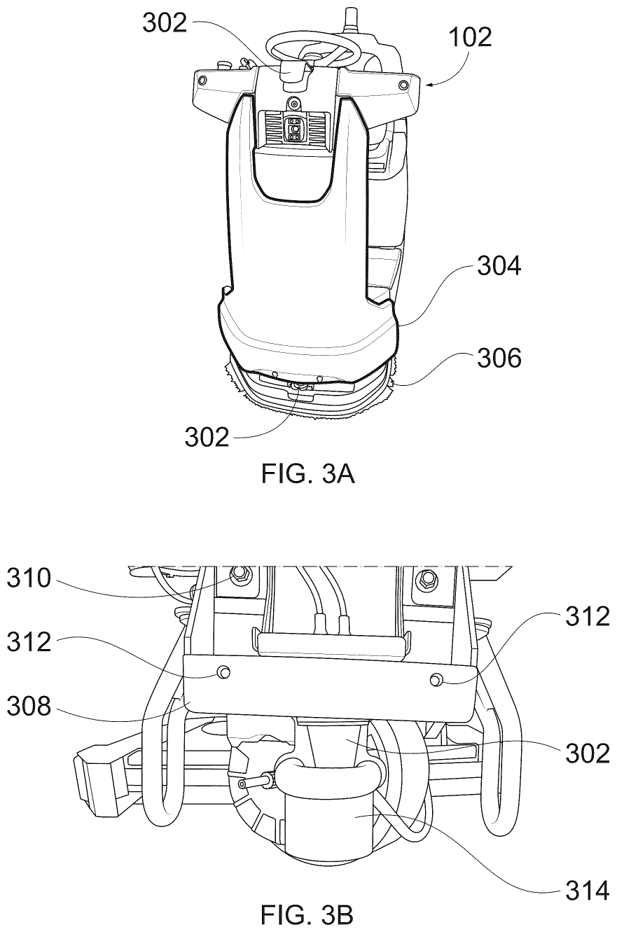

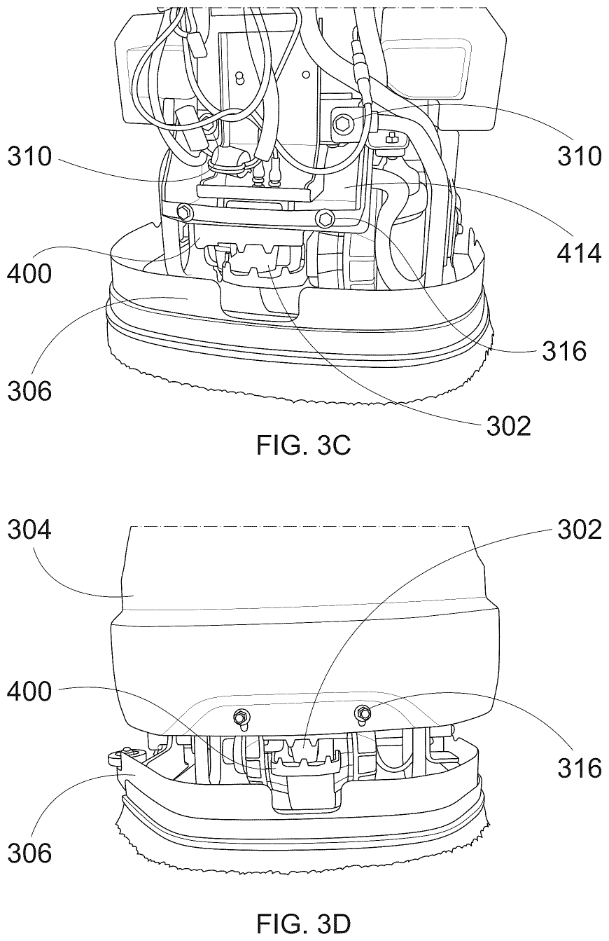

Currently, many robots utilize sensors, such as light detection and ranging (“LiDAR”) sensors, to sense various objects within their environment. Typically, these sensors operate on a planar measurement surface, such as spinning planar LiDAR sensors. In some instances, the objects the sensors are designed to detect may also pose a hazard to the sensors themselves. Namely, for LiDAR sensors, scratches in the lens may distort measurements and/or render the sensor inoperable. For example, a robot may utilize a planar LiDAR to sense objects at a small height (e.g., 5-20 inches) above a floor to detect, e.g., human legs, table legs, bottoms of a shelf/wall/tall object, shopping carts (e.g., via detecting a lower rack), and other small objects that the robot should avoid. On occasion, and primarily due to human actions, these small objects may collide with the sensor. For example, an autonomous robot may collide with a shopping cart pushed by a human. As another example, the robot may be controlled manually (e.g., in a manual mode), wherein the operator of the robot may collide with an object (e.g., a driver may use a large robot such as the one depicted in FIG. 3 below to push objects aside, rather than dismounting and moving the object prior to continuing). Often it is difficult to identify damaged sensors while these autonomous devices are being operated manually, wherein the sensor defect is only determined later during autonomous usage. Various contemporary solutions have been contemplated and are insufficient, namely adding protective meshes, transparent films, or other similar means of protection that often occlude the sensor to a degree, which hinders operation of the sensor/robot. Accordingly, there is a need in the art for a protective covering for sensors of a robot which do not impede the operation of the sensor. Further, as many robots are already existing and operating, the protective covering should additionally be capable of being coupled to existing robots and may be considered as a module. In other words a skilled artisan would appreciate that in referring to a device or module herein, a physical protective covering or cover is being referred to.

Various aspects of the novel systems, apparatuses, and methods disclosed herein are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting, the scope of the disclosure being defined by the appended claims and equivalents thereof.

The present disclosure provides for systems and apparatuses for a protective module for robotic sensors. As used herein, a robot may include mechanical and/or virtual entities configured to carry out a complex series of tasks or actions autonomously. In some exemplary embodiments, robots may be machines that are guided and/or instructed by computer programs and/or electronic circuitry. In some exemplary embodiments, robots may include electro-mechanical components that are configured for navigation, where the robot may move from one location to another. Such robots may include autonomous and/or semi-autonomous cars, floor cleaners, rovers, drones, planes, boats, carts, trams, wheelchairs, industrial equipment, stocking machines, mobile platforms, personal transportation devices (e.g., hover boards, SEGWAY® vehicles, etc.), trailer movers, vehicles, and the like. Robots may also include any autonomous and/or semi-autonomous machine for transporting items, people, animals, cargo, freight, objects, luggage, and/or anything desirable from one location to another.

As used herein, network interfaces may include any signal, data, or software interface with a component, network, or process including, without limitation, those of the FireWire (e.g., FW400, FW800, FWS800T, FWS1600, FWS3200, etc.), universal serial bus (“USB”) (e.g., USB 1.X. USB 2.0, USB 3.0, USB Type-C, etc.), Ethernet (e.g., 10/100, 10/100/1000 (Gigabit Ethernet), 10-Gig-E, etc.), multimedia over coax alliance technology (“MoCA”), Coaxsys (e.g., TVNET™), radio frequency tuner (e.g., in-band or OOB, cable modem, etc.), Wi-Fi (802.11), WiMAX (e.g., WiMAX (802.16)), PAN (e.g., PAN/802.15), cellular (e.g., 3G, 4G, or 5G including LTE/LTE-A/TD-LTE/TD-LTE, GSM, etc. variants thereof), IrDA families, etc. As used herein, Wi-Fi may include one or more of IEEE-Std. 802.11, variants of IEEE-Std. 802.11, standards related to IEEE-Std. 802.11 (e.g., 802.11 a/b/g/n/ac/ad/af/ah/ai/aj/aq/ax/ay), and/or other wireless standards.

As used herein, processor, microprocessor, and/or digital processor may include any type of digital processing device such as, without limitation, digital signal processors (“DSPs”), reduced instruction set computers (“RISC”), complex instruction set computers (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, and application-specific integrated circuits (“ASICs”). Such digital processors may be contained on a single unitary integrated circuit die or distributed across multiple components.

As used herein, computer program and/or software may include any sequence or human or machine cognizable steps that perform a function. Such computer program and/or software may be rendered in any programming language or environment including, for example, C/C++, C#, Fortran, COBOL, MATLAB™, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., “BREW”), and the like.

As used herein, connection, link, and/or wireless link may include a causal link between any two or more entities (whether physical or logical/virtual), which enables information exchange between the entities.

As used herein, computer and/or computing device may include, but are not limited to, personal computers (“PCs”) and minicomputers, whether desktop, laptop, or otherwise, mainframe computers, workstations, servers, personal digital assistants (“PDAs”), handheld computers, embedded computers, programmable logic devices, personal communicators, tablet computers, mobile devices, portable navigation aids, J2ME equipped devices, cellular telephones, smart phones, personal integrated communication or entertainment devices, and/or any other device capable of executing a set of instructions and processing an incoming data signal.

Detailed descriptions of the various embodiments of the system and methods of the disclosure are now provided. While many examples discussed herein may refer to specific exemplary embodiments, it will be appreciated that the described systems and methods contained herein are applicable to any kind of robot. Myriad other embodiments or uses for the technology described herein would be readily envisaged by those having ordinary skill in the art, given the contents of the present disclosure.

Advantageously, the systems and methods of this disclosure at least: (i) reduce the number of unexpected damages to robots caused by manual use (e.g., a robot experiencing damage in a manual mode may not be reported as inoperable until requested to operate autonomously); (ii) reduce operator time servicing robots by reducing the maintenance required to manage, repair or replace damaged sensors; and/or (iii) enable existing robots to quickly be fitted with protective coverings for their sensors that do not hinder performance. Other advantages are readily discernable by one having ordinary skill in the art given the contents of the present disclosure.

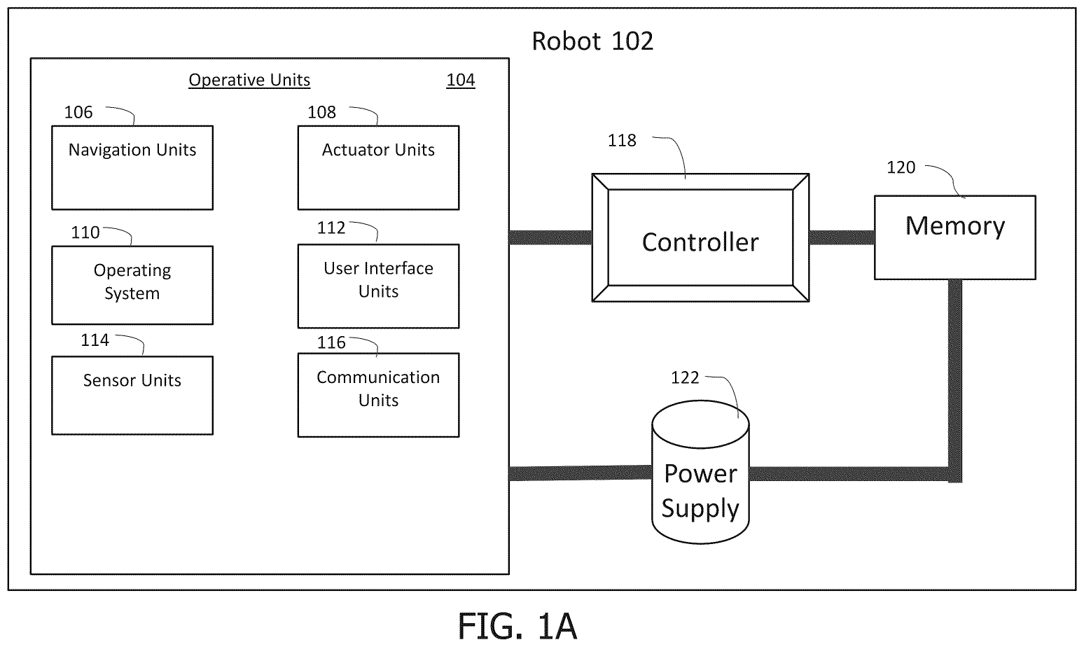

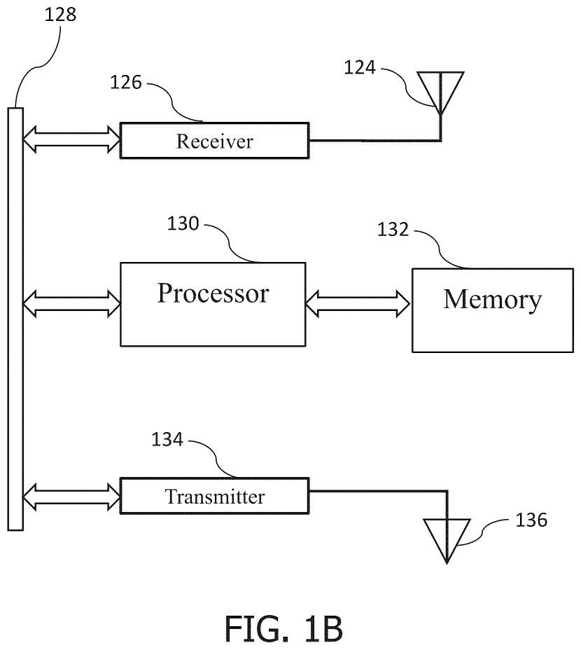

FIG. 1A is a functional block diagram of a robot 102 in accordance with some principles of this disclosure. As illustrated in FIG. 1A, robot 102 may include controller 118, memory 120, user interface unit 112, sensor units 114, navigation units 106, actuator units 108, and communications unit 116, as well as other components and subcomponents (some of which may not be illustrated). Although a specific embodiment is illustrated in FIG. 1A, it is appreciated that the architecture may be varied in certain embodiments as would be readily apparent to one of ordinary skill given the contents of the present disclosure. As used herein, robot 102 may be representative at least in part of any robot described in this disclosure.

Controller 118 may control the various operations performed by robot 102. Controller 118 may include and/or comprise one or more processors or processing devices (e.g., microprocessors) and other peripherals. As previously mentioned and used herein, processor, processing device, microprocessor, and/or digital processing device may include any type of digital processing device such as, without limitation, digital signal processors (“DSPs”), reduced instruction set computers (“RISC”), complex instruction set computers (“CISC”), microprocessors, gate arrays (e.g., field programmable gate arrays (“FPGAs”)), programmable logic device (“PLDs”), reconfigurable computer fabrics (“RCFs”), array processors, secure microprocessors and application-specific integrated circuits (“ASICs”). Peripherals may include hardware accelerators configured to perform a specific function using hardware elements such as, without limitation, encryption/description hardware, algebraic processors (e.g., tensor processing units, quadratic problem solvers, multipliers, etc.), data compressors, encoders, arithmetic logic units (“ALU”), and the like. Such digital processors may be contained on a single unitary integrated circuit die, or distributed across multiple components.

Controller 118 may be operatively and/or communicatively coupled to memory 120. Memory 120 may include any type of integrated circuit or other storage device configured to store digital data including, without limitation, read-only memory (“ROM”), random access memory (“RAM”), non-volatile random access memory (“NVRAM”), programmable read-only memory (“PROM”), electrically erasable programmable read-only memory (“EEPROM”), dynamic random-access memory (“DRAM”). Mobile DRAM, synchronous DRAM (“SDRAM”), double data rate SDRAM (“DDR/2 SDRAM”), extended data output (“EDO”) RAM, fast page mode RAM (“FPM”), reduced latency DRAM (“RLDRAM”), static RAM (“SRAM”), flash memory (e.g., NAND/NOR), memristor memory, pseudostatic RAM (“PSRAM”), etc. Memory 120 may provide computer-readable instructions and data to controller 118. For example, memory 120 may be a non-transitory, computer-readable storage apparatus and/or medium having a plurality of instructions stored thereon, the instructions being executable by a processing apparatus (e.g., controller 118) to operate robot 102. In some cases, the computer-readable instructions may be configured to, when executed by the processing apparatus, cause the processing apparatus to perform the various methods, features, and/or functionality described in this disclosure. Accordingly, controller 118 may perform logical and/or arithmetic operations based on program instructions stored within memory 120. In some cases, the instructions and/or data of memory 120 may be stored in a combination of hardware, some located locally within robot 102, and some located remote from robot 102 (e.g., in a cloud, server, network, etc.).

It should be readily apparent to one of ordinary skill in the art that a processor may be internal to or on board robot 102 and/or may be external to robot 102 and be communicatively coupled to controller 118 of robot 102 utilizing communication units 116 wherein the external processor may receive data from robot 102, process the data, and transmit computer-readable instructions back to controller 118. In at least one non-limiting exemplary embodiment, the processor may be on a remote server (not shown).

In some exemplary embodiments, memory 120, shown in FIG. 1A, may store a library of sensor data. In some cases, the sensor data may be associated at least in part with objects and/or people. In exemplary embodiments, this library may include sensor data related to objects and/or people in different conditions, such as sensor data related to objects and/or people with different compositions (e.g., materials, reflective properties, molecular makeup, etc.), different lighting conditions, angles, sizes, distances, clarity (e.g., blurred, obstructed/occluded, partially off frame, etc.), colors, surroundings, and/or other conditions. The sensor data in the library may be taken by a sensor (e.g., a sensor of sensor units 114 or any other sensor) and/or generated automatically, such as with a computer program that is configured to generate/simulate (e.g., in a virtual world) library sensor data (e.g., which may generate/simulate these library data entirely digitally and/or beginning from actual sensor data) from different lighting conditions, angles, sizes, distances, clarity (e.g., blurred, obstructed/occluded, partially off frame, etc.), colors, surroundings, and/or other conditions. The number of images in the library may depend at least in part on one or more of the amount of available data, the variability of the surrounding environment in which robot 102 operates, the complexity of objects and/or people, the variability in appearance of objects, physical properties of robots, the characteristics of the sensors, and/or the amount of available storage space (e.g., in the library, memory 120, and/or local or remote storage). In exemplary embodiments, at least a portion of the library may be stored on a network (e.g., cloud, server, distributed network, etc.) and/or may not be stored completely within memory 120. As yet another exemplary embodiment, various robots (e.g., those that are commonly associated, such as robots by a common manufacturer, user, network, etc.) may be networked so that data captured by individual robots are collectively shared with other robots. In such a fashion, these robots may be configured to learn and/or share sensor data in order to facilitate the ability to readily detect and/or identify errors and/or assist events.

Still referring to FIG. 1A, operative units 104 may be coupled to controller 118, or any other controller, to perform the various operations described in this disclosure. One, more, or none of the modules in operative units 104 may be included in some embodiments. Throughout this disclosure, reference may be to various controllers and/or processing devices. In some embodiments, a single controller (e.g., controller 118) may serve as the various controllers and/or processors described. In other embodiments, different controllers and/or processors may be used, such as controllers and/or processors used particularly for one or more operative units 104. Controller 118 may send and/or receive signals, such as power signals, status signals, data signals, electrical signals, and/or any other desirable signals, including discrete and analog signals to operative units 104. Controller 118 may coordinate and/or manage operative units 104, and/or set timings (e.g., synchronously or asynchronously), turn off/on control power budgets, receive/send network instructions and/or updates, update firmware, send interrogatory signals, receive and/or send statuses, and/or perform any operations for running features of robot 102.

Returning to FIG. 1A, operative units 104 may include various units that perform functions for robot 102. For example, operative units 104 includes at least navigation units 106, actuator units 108, user interface units 112, sensor units 114, and communication units 116. Operative units 104 may also comprise other units such as specifically configured task units (not shown) that provide the various functionality of robot 102. In exemplary embodiments, operative units 104 may be instantiated in software, hardware, or both software and hardware. For example, in some cases, units of operative units 104 may comprise computer implemented instructions executed by a controller. In exemplary embodiments, units of operative unit 104 may comprise hardcoded logic (e.g., ASICS). In exemplary embodiments, units of operative units 104 may comprise both computer-implemented instructions executed by a controller and hardcoded logic. Where operative units 104 are implemented in part in software, operative units 104 may include units/modules of code configured to provide one or more functionalities.

In exemplary embodiments, navigation units 106 may include systems and methods that may computationally construct and update a map of an environment, localize robot 102 (e.g., find its position) in a map, and navigate robot 102 to/from destinations. The mapping may be performed by imposing data obtained in part by sensor units 114 into a computer-readable map representative at least in part of the environment. In exemplary embodiments, a map of an environment may be uploaded to robot 102 through user interface units 112, uploaded wirelessly or through wired connection, or taught to robot 102 by a user.

In exemplary embodiments, navigation units 106 may include components and/or software configured to provide directional instructions for robot 102 to navigate. Navigation units 106 may process maps, routes, and localization information generated by mapping and localization units, data from sensor units 114, and/or other operative units 104.

Still referring to FIG. 1A, actuator units 108 may include actuators such as electric motors, gas motors, driven magnet systems, solenoid/ratchet systems, piezoelectric systems (e.g., inchworm motors), magnetostrictive elements, gesticulation, and/or any way of driving an actuator known in the art. By way of illustration, such actuators may actuate the wheels for robot 102 to navigate a route; navigate around obstacles; and/or repose cameras and sensors. According to exemplary embodiments, actuator unit 108 may include systems that allow movement of robot 102, such as motorized propulsion. For example, motorized propulsion may move robot 102 in a forward or backward direction, and/or be used at least in part in turning robot 102 (e.g., left, right, and/or any other direction). By way of illustration, actuator unit 108 may control if robot 102 is moving or is stopped and/or allow robot 102 to navigate from one location to another location.

Actuator unit 108 may also include any system used for actuating and, in some cases actuating task units to perform tasks. For example, actuator unit 108 may include driven magnet systems, motors/engines (e.g., electric motors, combustion engines, steam engines, and/or any type of motor/engine known in the art), solenoid/ratchet system, piezoelectric system (e.g., an inchworm motor), magnetostrictive elements, gesticulation, and/or any actuator known in the art.

According to exemplary embodiments, sensor units 114 may comprise systems and/or methods that may detect characteristics within and/or around robot 102. Sensor units 114 may comprise a plurality and/or a combination of sensors. Sensor units 114 may include sensors that are internal to robot 102 or external, and/or have components that are partially internal and/or partially external. In some cases, sensor units 114 may include one or more exteroceptive sensors, such as sonars, light detection and ranging (“LiDAR”) sensors, radars, lasers, cameras (including video cameras (e.g., red-blue-green (“RBG”) cameras, infrared cameras, three-dimensional (“3D”) cameras, thermal cameras, etc.), time of flight (“ToF”) cameras, structured light cameras, etc.), antennas, motion detectors, microphones, and/or any other sensor known in the art. According to some exemplary embodiments, sensor units 114 may collect raw measurements (e.g., currents, voltages, resistances, gate logic, etc.) and/or transformed measurements (e.g., distances, angles, detected points in obstacles, etc.). In some cases, measurements may be aggregated and/or summarized. Sensor units 114 may generate data based at least in part on distance or height measurements. Such data may be stored in data structures, such as matrices, arrays, queues, lists, arrays, stacks, bags, etc.

According to exemplary embodiments, sensor units 114 may include sensors that may measure internal characteristics of robot 102. For example, sensor units 114 may measure temperature, power levels, statuses, and/or any characteristic of robot 102. In some cases, sensor units 114 may be configured to determine the odometry of robot 102. For example, sensor units 114 may include proprioceptive sensors, which may comprise sensors such as accelerometers, inertial measurement units (“IMU”), odometers, gyroscopes, speedometers, cameras (e.g. using visual odometry), clock/timer, and the like. Odometry may facilitate autonomous navigation and/or autonomous actions of robot 102. This odometry may include robot 102's position (e.g., where position may include robot's location, displacement and/or orientation, and may sometimes be interchangeable with the term pose as used herein) relative to the initial location. Such data may be stored in data structures, such as matrices, arrays, queues, lists, stacks, bags, etc. According to exemplary embodiments, the data structure of the sensor data may be called an image.

According to exemplary embodiments, sensor units 114 may be in part external to the robot 102 and coupled to communications units 116. For example, a security camera within an environment of a robot 102 may provide a controller 118 of the robot 102 with a video feed via wired or wireless communication channel(s). In some instances, sensor units 114 may include sensors configured to detect a presence of an object at a location such as, for example without limitation, a pressure or motion sensor may be disposed at a shopping cart storage location of a grocery store, wherein the controller 118 of the robot 102 may utilize data from the pressure or motion sensor to determine if the robot 102 should retrieve more shopping carts for customers.

According to exemplary embodiments, user interface units 112 may be configured to enable a user to interact with robot 102 (for example, exchange information with the robot). For example, user interface units 112 may include touch panels, buttons, keypads/keyboards, ports (e.g., universal serial bus (“USB”), digital visual interface (“DVI”), Display Port, E-Sata, Firewire, PS/2, Serial, VGA, SCSI, audioport, high-definition multimedia interface (“HDMI”), personal computer memory card international association (“PCMCIA”) ports, memory card ports (e.g., secure digital (“SD”) and miniSD), and/or ports for computer-readable medium), mice, rollerballs, consoles, vibrators, audio transducers, and/or any interface for a user to input and/or receive data and/or commands, whether coupled wirelessly or through wires. Users may interact through voice commands or gestures. User interface units 218 may include a display, such as, without limitation, liquid crystal display (“LCDs”), light-emitting diode (“LED”) displays, LED LCD displays, in-plane-switching (“IPS”) displays, cathode ray tubes, plasma displays, high definition (“HD”) panels, 4K displays, retina displays, organic LED displays, touchscreens, surfaces, canvases, and/or any displays, televisions, monitors, panels, and/or devices known in the art for visual presentation. According to exemplary embodiments user interface units 112 may be positioned on the body of robot 102. According to exemplary embodiments, user interface units 112 may be positioned away from the body of robot 102 but may be communicatively coupled to robot 102 (e.g., via communication units including transmitters, receivers, and/or transceivers) directly or indirectly (e.g., through a network, server, and/or a cloud). According to exemplary embodiments, user interface units 112 may include one or more projections of images on a surface (e.g., the floor) proximally located to the robot, e.g., to provide information to the occupant or to people around the robot. The information could be the direction of future movement of the robot, such as an indication of moving forward, left, right, back, at an angle, and/or any other direction. In some cases, such information may utilize arrows, colors, symbols, etc.

According to exemplary embodiments, communications unit 116 may include one or more receivers, transmitters, and/or transceivers. Communications unit 116 may be configured to send/receive a transmission protocol, such as BLUETOOTH®, ZIGBEE®, Wi-Fi, induction wireless data transmission, radio frequencies, radio transmission, radio-frequency identification (“RFID”), near-field communication (“NFC”), infrared, network interfaces, cellular technologies such as 3G (3.5G, 3.75G. 3GPP/3GPP2/HSPA+), 4G (4GPP/4GPP2/LTE/LTE-TDD/LTE-FDD), 5G (5GPP/5GPP2), or 5G LTE (long-term evolution, and variants thereof including LTE-A, LTE-U, LTE-A Pro, etc.), high-speed downlink packet access (“HSDPA”), high-speed uplink packet access (“HSUPA”), time division multiple access (“TDMA”), code division multiple access (“CDMA”) (e.g., IS-95A, wideband code division multiple access (“WCDMA”), etc.), frequency hopping spread spectrum (“FHSS”), direct sequence spread spectrum (“DSSS”), global system for mobile communication (“GSM”), Personal Area Network (“PAN”) (e.g., PAN/802.15), worldwide interoperability for microwave access (“WiMAX”), 802.20, long term evolution (“LTE”) (e.g., LTE/LTE-A), time division LTE (“TD-LTE”), global system for mobile communication (“GSM”), narrowband/frequency-division multiple access (“FDMA”), orthogonal frequency-division multiplexing (“OFDM”), analog cellular, cellular digital packet data (“CDPD”), satellite systems, millimeter wave or microwave systems, acoustic, infrared (e.g., infrared data association (“IrDA”)), and/or any other form of wireless data transmission.

Communications unit 116 may also be configured to send/receive signals utilizing a transmission protocol over wired connections, such as any cable that has a signal line and ground. For example, such cables may include Ethernet cables, coaxial cables, Universal Serial Bus (“USB”), Fire Wire, and/or any connection known in the art. Such protocols may be used by communications unit 116 to communicate to external systems, such as computers, smart phones, tablets, data capture systems, mobile telecommunications networks, clouds, servers, or the like. Communications unit 116 may be configured to send and receive signals comprising numbers, letters, alphanumeric characters, and/or symbols. In some cases, signals may be encrypted, using algorithms such as 128-bit or 256-bit keys and/or other encryption algorithms complying with standards such as the Advanced Encryption Standard (“AES”), RSA, Data Encryption Standard (“DES”), Triple DES, and the like. Communications unit 116 may be configured to send and receive statuses, commands, and other data/information. For example, communications unit 116 may communicate with a user operator to allow the user to control robot 102. Communications unit 116 may communicate with a server/network (e.g., a network) in order to allow robot 102 to send data, statuses, commands, and other communications to the server. The server may also be communicatively coupled to computer(s) and/or device(s) that may be used to monitor and/or control robot 102 remotely. Communications unit 116 may also receive updates (e.g., firmware or data updates), data, statuses, commands, and other communications from a server for robot 102.

In exemplary embodiments, operating system 110 may be configured to manage memory 120, controller 118, power supply 122, modules in operative units 104, and/or any software, hardware, and/or features of robot 102. For example, and without limitation, operating system 110 may include device drivers to manage hardware recourses for robot 102.

In exemplary embodiments, power supply 122 may include one or more batteries, including, without limitation, lithium, lithium ion, nickel-cadmium, nickel-metal hydride, nickel-hydrogen, carbon-zinc, silver-oxide, zinc-carbon, zinc-air, mercury oxide, alkaline, or any other type of battery known in the art. Certain batteries may be rechargeable, such as wirelessly (e.g., by resonant circuit and/or a resonant tank circuit) and/or plugging into an external power source. Power supply 122 may also be any supplier of energy, including wall sockets and electronic devices that convert solar, wind, water, nuclear, hydrogen, gasoline, natural gas, fossil fuels, mechanical energy, steam, and/or any power source into electricity, including converting alternating current (AC) power to direct current (DC) power.

One or more of the units described with respect to FIG. 1A (including memory 120, controller 118, sensor units 114, user interface unit 112, actuator unit 108, communications unit 116, mapping and localization unit 126, and/or other units) may be integrated onto robot 102, such as in an integrated system. However, according to some exemplary embodiments, one or more of these units may be part of an attachable module. This module may be attached to an existing apparatus to automate so that it behaves as a robot. Accordingly, the features described in this disclosure with reference to robot 102 may be instantiated in a module that may be attached to an existing apparatus and/or integrated onto robot 102 in an integrated system. Moreover, in some cases, a person having ordinary skill in the art would appreciate from the contents of this disclosure that at least a portion of the features described in this disclosure may also be run remotely, such as in a cloud, network, and/or server.

As used herein, a robot 102, a controller 118, or any other controller, processing device, or robot performing a task, operation or transformation illustrated in the figures below comprises a controller executing computer readable instructions stored on a non-transitory computer readable storage apparatus, such as memory 120, as would be appreciated by one skilled in the art.

Next referring to FIG. 1B, the architecture of a processor or processing device 138 is illustrated according to an exemplary embodiment. As illustrated in FIG. 1B, the processing device 138 includes a data bus 128, a receiver 126, a transmitter 134, at least one processor 130, and a memory 132. The receiver 126, the processor 130 and the transmitter 134 all communicate with each other via the data bus 128. The processor 130 is configurable to access the memory 132, which stores computer code or computer readable instructions in order for the processor 130 to execute specialized algorithms. As illustrated in FIG. 1B, memory 132 may comprise some, none, different, or all of the features of memory 120 previously illustrated in FIG. 1A. The algorithms executed by the processor 130 are discussed in further detail below. The receiver 126 as shown in FIG. 1B is configurable to receive input signals 124. The input signals 124 may comprise signals from a plurality of operative units 104 illustrated in FIG. 1A including, but not limited to, sensor data from sensor units 114, user inputs, motor feedback, external communication signals (e.g., from a remote server), and/or any other signal from an operative unit 104 requiring further processing. The receiver 126 communicates these received signals to the processor 130 via the data bus 128. As one skilled in the art would appreciate, the data bus 128 is the means of communication between the different components—receiver, processor, and transmitter—in the processing device. The processor 130 executes the algorithms, as discussed below, by accessing specialized computer-readable instructions from the memory 132. Further detailed description as to the processor 130 executing the specialized algorithms in receiving, processing and transmitting of these signals is discussed above with respect to FIG. 1A. The memory 132 is a storage medium for storing computer code or instructions. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium may include volatile, nonvolatile, dynamic, static, read/write, read-only, random-access, sequential-access, location-addressable, file-addressable, and/or content-addressable devices. The processor 130 may communicate output signals to transmitter 134 via data bus 128 as illustrated. The transmitter 134 may be configurable to further communicate the output signals to a plurality of operative units 104 illustrated by signal output 136.

One of ordinary skill in the art would appreciate that the architecture illustrated in FIG. 1B may illustrate an external server architecture configurable to effectuate the control of a robotic apparatus from a remote location, such as a remote server. That is, the server may also include a data bus, a receiver, a transmitter, a processor, and a memory that stores specialized computer readable instructions thereon.

One of ordinary skill in the art would appreciate that a controller 118 of a robot 102 may include one or more processing devices 138 and may further include other peripheral devices used for processing information, such as ASICS, DPS, proportional-integral-derivative (“PID”) controllers, hardware accelerators (e.g., encryption/decryption hardware), and/or other peripherals (e.g., analog to digital converters) described above in FIG. 1A. The other peripheral devices when instantiated in hardware are commonly used within the art to accelerate specific tasks (e.g., multiplication, encryption, etc.) which may alternatively be performed using the system architecture of FIG. 1B. In some instances, peripheral devices are used as a means for intercommunication between the controller 118 and operative units 104 (e.g., digital to analog converters and/or amplifiers for producing actuator signals). Accordingly, as used herein, the controller 118 executing computer readable instructions to perform a function may include one or more processing devices 138 thereof executing computer readable instructions and, in some instances, the use of any hardware peripherals known within the art. Controller 118 may be illustrative of various processing devices 138 and peripherals integrated into a single circuit die or distributed to various locations of the robot 102 which receive, process, and output information to/from operative units 104 of the robot 102 to effectuate control of the robot 102 in accordance with instructions stored in a memory 120, 132. For example, controller 118 may include a plurality of processing devices 138 for performing high level tasks (e.g., planning a route to avoid obstacles) and processing devices 138 for performing low-level tasks (e.g., producing actuator signals in accordance with the route).

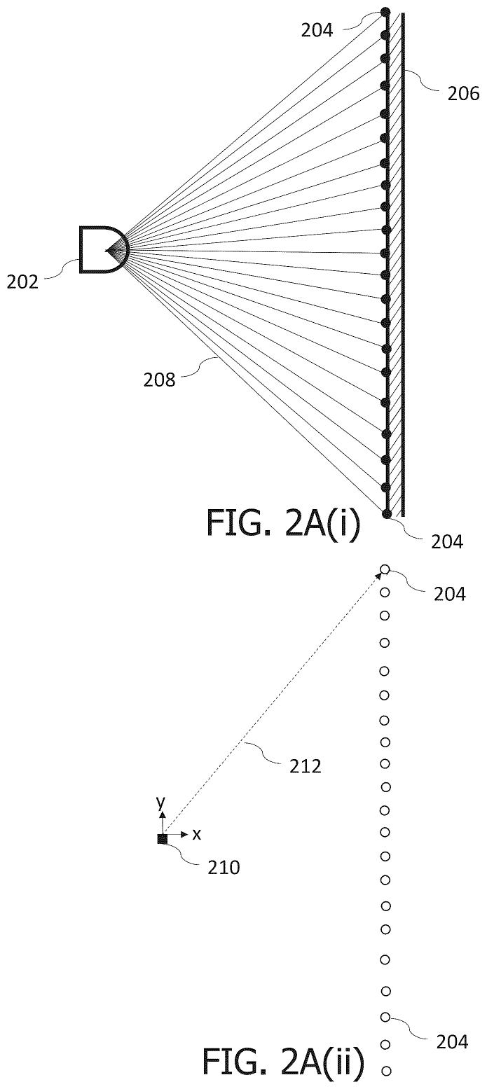

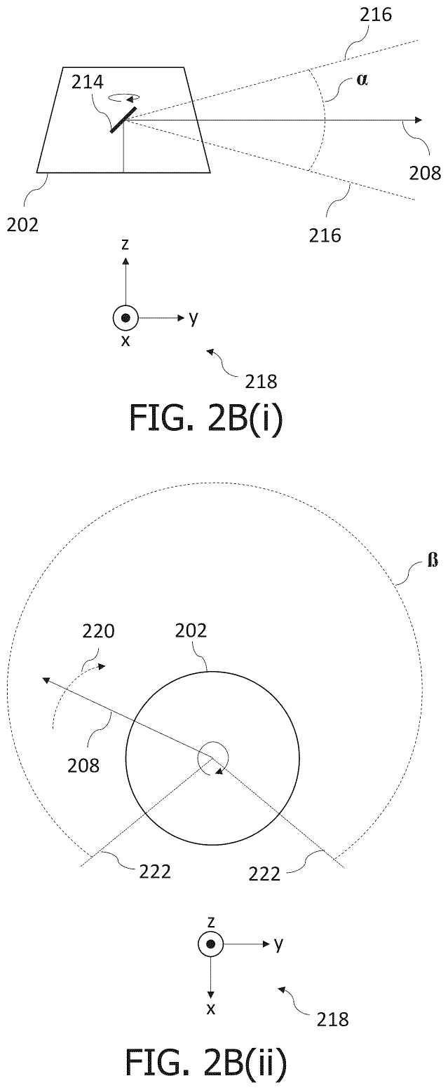

FIG. 2A(i-ii) illustrates a planar light detection and ranging (“LiDAR”) sensor 202 coupled to a robot 102, which collects distance measurements to a wall 206 along a measurement plane in accordance with some exemplary embodiments of the present disclosure. Planar LiDAR sensor 202, illustrated in FIG. 2A(i), may be configured to collect distance measurements to the wall 206 by projecting a plurality of beams 208 of photons at discrete angles along a measurement plane and determining the distance to the wall 206 based on a time of flight (“ToF”) of the photons leaving the LiDAR sensor 202, reflecting off the wall 206, and returning back to the LiDAR sensor 202. The measurement plane of the planar LiDAR 202 comprises a plane along which the beams 208 are emitted which, for this exemplary embodiment illustrated, is the plane of the page.

Individual beams 208 of photons may localize respective points 204 of the wall 206 in a point cloud, the point cloud comprising a plurality of points 204 localized in 2D or 3D space as illustrated in FIG. 2A(ii). The points 204 may be defined about a local origin 210 of the sensor 202. Distance 212 to a point 204 may comprise half the time of flight of a photon of a respective beam 208 used to measure the point 204 multiplied by the speed of light, wherein coordinate values (x, y) of each respective point 204 depends both on distance 212 and an angle at which the respective beam 208 was emitted from the sensor 202. The local origin 210 may comprise a predefined point of the sensor 202 to which all distance measurements are referenced (e.g., location of a detector within the sensor 202, focal point of a lens of sensor 202, etc.). For example, a 5-meter distance measurement to an object corresponds to 5 meters from the local origin 210 to the object.

According to at least one non-limiting exemplary embodiment, sensor 202 may be illustrative of a depth camera or other ToF sensor configurable to measure distance, wherein the sensor 202 being a planar LiDAR sensor is not intended to be limiting. Depth cameras may operate similar to planar LiDAR sensors (i.e., measure distance based on a ToF of beams 208); however, depth cameras may emit beams 208 using a single pulse or flash of electromagnetic energy, rather than sweeping a laser beam across a field of view. Depth cameras may additionally comprise a two-dimensional field of view rather than a one-dimensional, planar field of view.

According to at least one non-limiting exemplary embodiment, sensor 202 may be illustrative of a structured light LiDAR sensor configurable to sense distance and shape of an object by projecting a structured pattern onto the object and observing deformations of the pattern. For example, the size of the projected pattern may represent distance to the object and distortions in the pattern may provide information of the shape of the surface of the object. Structured light sensors may emit beams 208 along a plane as illustrated or in a predetermined pattern (e.g., a circle or series of separated parallel lines).

FIG. 2B(i-ii) illustrates a planar spinning or rotating LiDAR sensor from two perspective views in accordance with some exemplary embodiments of this disclosure. First, in FIG. 2B(i) a LiDAR sensor 202 is depicted from a side-facing view, wherein the planar LiDAR sensor 202 measures, ideally (i.e., absent noise), along the x-y plane denoted by reference coordinates 218. To measure along the x-y plane, the LiDAR sensor 202 may comprise a spinning mirror or lensed apparatus 214, which reflects a single beam 208 outward into the environment, wherein the spinning of the mirror 214 causes the beam 208 to be transmitted outward into the environment at a plurality of angles along the x-y plane.

Absent noise, atmospheric diffusion, imperfections in mirror 214, and/or other distortions, the beam 208 will be emitted perfectly along the x-y plane as defined by coordinates 218. However, in practice, LiDAR sensors 202 are often subject to noise, imperfections, an atmosphere/transmission medium, and other perturbations that may cause the beam 208 to be emitted at an angle away from the x-y plane. The typical variance of the beam 208 is shown via boundary lines 216 (FIG. 2B(i)), which denote the upper and lower maximum bounds of angular deviation of the beam 208 from the x-y plane. The angle formed by these boundary lines will be referred to herein as angle α, or the angle of deviation. Angle α represents the angular variance or deviance from the x-y plane of the beams 208 emitted from the LiDAR sensor 202. Angle α is defined within the y-z plane. Although angle α is shown comprising its vertex at the reflection point of the beam 208 on the mirror 214, angle α may comprise a different vertex, e.g., at the surface boundary of the LiDAR 202 external lens/covering. Typically, angle α is specified by, e.g., a manufacturer of the LiDAR 202 sensor based on a plurality of additional factors such as operation temperature, lens distortions, and other intrinsic properties of the sensor 202.

Next, FIG. 2B(ii) shows the same LiDAR sensor shown in FIG. 2B(i) from a top-down view. The top-down view depicts the beam 208 spinning around the center of the LiDAR 202 (mirror 214 omitted for clarity). Some LiDAR sensors may only sample returning/reflected beams 208 within a specified angle in the x-y plane. Such angle is often referred to as the “field of view” (“FOV”) angle of the LiDAR sensor 202 and will be denoted herein as angle β. The FOV is shown in FIG. 2B(ii) via boundaries 222. In some embodiments, angle β may be equal to 360° or smaller than as illustrated.

One skilled in the art will appreciate that angle α is the result of noise and atmospheric diffusion, which may vary over time, whereas angle β is determined by the sampling area of the LiDAR sensor and can be presumed herein to be a fixed parameter.

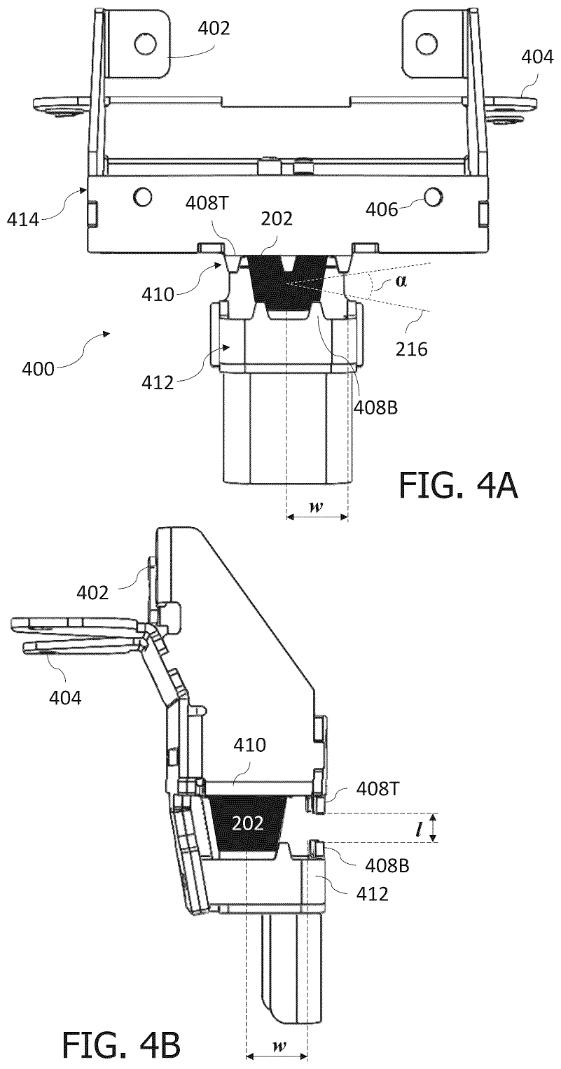

FIG. 3A-D illustrate an installation process for coupling a protective module 400, shown in a schematic in FIG. 4A-B, onto a robot 102, according to an exemplary embodiment. The robot 102 in this embodiment is a ride-along floor cleaning robot configured to brush, mop, and/or scrub floors beneath it as it navigates in either in a manual, fully autonomous, or semi-autonomous (e.g., assisted navigation) mode. It is appreciated, however, that the robot 102 could be any other robot configured for other functions provided it includes at least one LiDAR sensor which benefits from protection, wherein exemplary use of a robotic floor cleaner is not intended to be limiting.

First, in FIG. 3A, the robot 102 is shown from a front-facing view. The robot 102 comprises a front-facing planar LiDAR sensor 302 (partially occluded and depicted more clearly below in FIG. 3B) located approximately four inches from the floor. The field of view extends away from the robot 102 along the forward direction (i.e., out of the page). The LiDAR sensor 302 is configured to detect objects close to or touching a floor, such as boxes, shelves, people, animals, or other things, wherein the robot 102 should avoid these objects while navigating. The robot 102 may comprise another planar LiDAR 302 which can also be configured with a protective module 400, however for simplicity only the front lower LiDAR 302 will be configured with a protective module 400 to prevent collisions with, e.g., lower racks of shopping carts.

Currently, the only protection to the LiDAR 302 includes a front cover 304 and a brush 306, wherein neither of these components are designed specifically for protection of the LiDAR 302 but may provide marginal protection against large objects entering between and colliding with the LiDAR 302 lens. In one exemplary scenario, the robot 102 may operate in a retail environment comprising a plurality of humans and shopping carts, wherein the lower racks of shopping carts are approximately of the same height of the LiDAR 302 and thin enough to pass between front cover 304 and brush 306, and therefore pose a great risk of collision with the sensor 302. In another exemplary scenario, protrusions of shelves, displays, or other (typically thin or highly reflective) objects may pose a risk of collision with the LiDAR sensor 302. Accordingly, a protective module 400 as disclosed herein will be coupled to this lower LiDAR sensor 302.

FIG. 3B depicts the robot 102 in a front-facing close up view, wherein the front panel 304 and brush 306 have been removed, according to the exemplary embodiment. The front panel 304 and/or brush 306 may be coupled to the robot 102 chassis via screws, latches, or other disconnect able mechanisms as to enable maintenance of the brush 306 and/or electrical components behind the panel 304 for installing the protective module 400 and/or other maintenance common reasons. That is, these components 304, 306 are already configured to be temporarily removable.

As shown, the LiDAR sensor 302 lens is now entirely exposed. One may appreciate that thin (e.g., about 3 inch) objects, such as protrusions from shelves, lower shopping cart racks, etc., may easily collide with the lens of the LiDAR 302, even if the lower brush 306 is coupled to the robot 102. A metallic support 314 is included in this embodiment of robot 102; however, this lower support 314 does not include any added protection to the LiDAR 302 lens as shown by the lack of occlusion of the lens from this front-facing perspective. Support 314 is utilized, in this embodiment, to perform small calibration adjustments to the sensor 302. While support 314 may protect the LiDAR 302 lens from thick objects, it does not protect it from thin ones.

The LiDAR 302 is coupled to the robot 102 via a frame 308 which couples to the robot 102 chassis via bolts 310. The frame 308 may further include threads or holes 312 which couple the lower part of the front panel 304 (not shown) to the robot 102 chassis. In some embodiments, these threads 312 may be utilized to couple the protective module disclosed herein to the robot 102. In other embodiments, the entire frame 308 may be decoupled from the robot 102 and replaced with a new frame which includes the protective module disclosed herein, which is depicted next in FIG. 3C. While removing or adjusting the frame 308 it is recommended to wrap the LiDAR with a temporary protective covering, such as a plastic film, to avoid potential scratches of the lens. The frame 308 may contain electrical interfaces for coupling the LiDAR sensor 302, and other components (e.g., actuators, etc.) to the controller 118 located elsewhere. Although a specific embodiment of frame 308 is shown, one skilled in the art may appreciate that the frame 308 is only an exemplary means of affixing the sensor 302 to the robot 102 body and the specific size, shape, and form of the frame 308 may vary based on (i) the body form of the robot 102, and (ii) where on the robot 102 the LiDAR 302 is to be coupled to, wherein other mechanisms for affixing the sensor 302 to the robot 102 are also applicable with the protective module 400 disclosed herein.

FIG. 3C depicts the robot 102 having a protective module 400 coupled thereto, according to an exemplary embodiment. In this embodiment, the frame 308 was removed by decoupling bolts 310 and affixing a new frame 414 to the robot 102, the new frame 414 being shown separately from the robot 102 below in FIG. 4A-B. The new frame 414 is coupled to the robot 102 by re-attaching the bolts 310. The new frame 414 includes a protective module 400 which, as described in more detail below, includes a plurality of alternating teeth that provide protection to the LiDAR 302 lens. Once the protective module 400 is coupled to the robot 102, the front panel 304 and/or brush 306 may be re-affixed to the robot 102, as shown in FIG. 3D, according to the exemplary embodiment. The front panel 304 may be coupled to the frame 414, and thereby the robot 102, via bolts 316. Advantageously, the robot 102 now includes a protective cover over its LiDAR sensor 302 without the need for replacing the sensor 302 and/or replacing a substantial number of mechanical parts or specialized tools.

In this exemplary embodiment, an existing robot 102 is being reconfigured with the protective module 400 disclosed herein. It is appreciated that removal of the prior frame 308 is not necessary to utilize the protective module 400, wherein the module 400 could be installed during production of the robot 102. Further, replacement of the prior frame 308 with the new frame 414 may not always be necessary, wherein the frame 414 substantially resembles the old frame 308, but replacing the entire frame 308 could be beneficial for quicker retrofitting of robots 102 operating in the field. In some instances, it may be necessary if one or more mechanical/electrical couplers (e.g., threads 312, cable interfaces, etc.) in the new frame 414 are not present in the old frame 308.

FIG. 4A is a front facing view of a LiDAR sensor 202 encased within a protective module 400, according to an exemplary embodiment. The protective module 400 comprises three main components: a top portion 410, a bottom portion 412, and a connection interface or frame 414 described further below. These three portions may be mechanically coupled or as a single (e.g., welded) part and are denoted separately for explaining functionality. The portions 410, 412, 414 may comprise of various plastics, metals, and/or other solid durable material. The top and bottom portions 410, 412 both include toothed edges each comprising a plurality of teeth 408. As used herein, the terms “tooth” and “teeth” refer to one or more spaced-apart projection(s) that stick out in a row on an edge of an otherwise flat top or bottom portions 410, 412 of the module. The teeth 408 of the top portion 410, denoted 408-T hereinafter, extend downwards in front of the sensor 202 toward the bottom portion, and the teeth 408 of the bottom portion 412, denoted 408-B hereinafter, extend upwards toward the top portion 410. The teeth of the top portion 408-T and bottom portion 408-B are misaligned, for reasons discussed later. That is, the teeth 408-T of the top portion 410 align with the spacings formed by the teeth 408-B of the bottom portion 412, and vice versa.

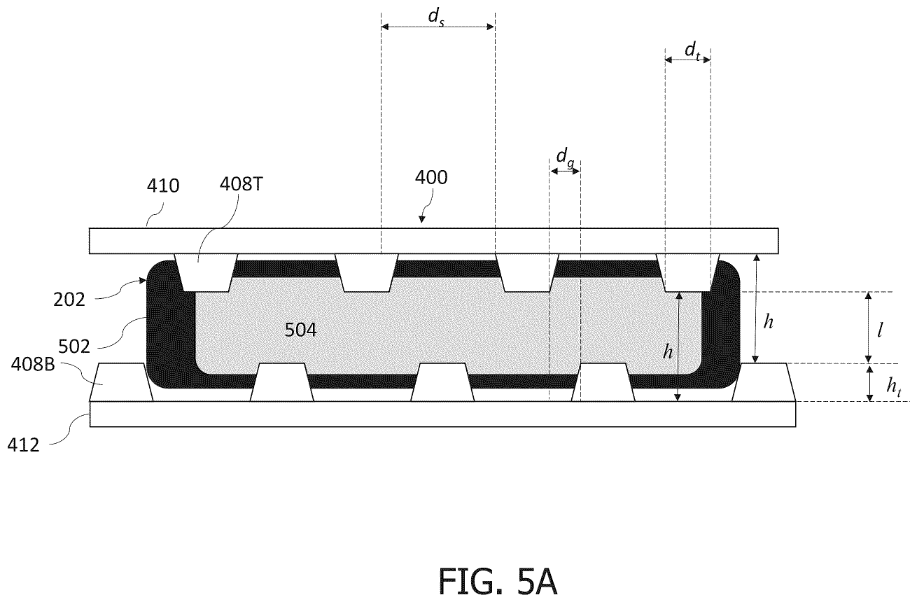

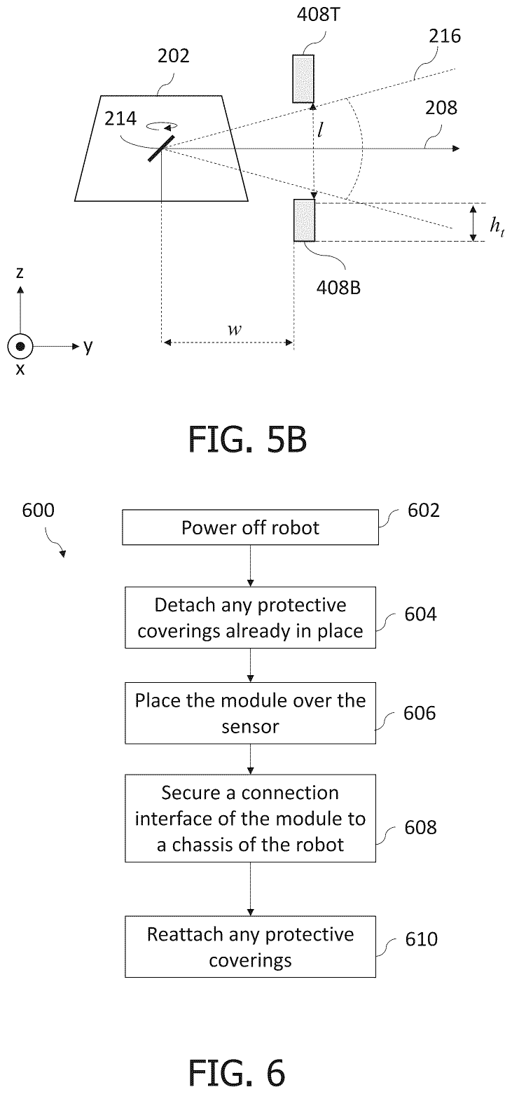

The teeth are positioned in front of the sensor 202 lens, thereby blocking some of the outgoing and incoming signals. The outgoing beams 208 includes a variance of angle α from an x-y plane due to atmospheric diffusion and noise, as described in FIG. 2B(i) above, from the lens of the sensor 202. The teeth of the top and bottom portions 410, 412 are a distance w from the emission/focal point of the signal from the sensor 202. Using this distance and the known beam variance α, a minimum bound on the gap between the teeth of the top and bottom portions is determined. Accordingly, such gap (denoted as distance l in FIG. 4B) must be at least wide enough to allow the outgoing signal to be emitted without reflection from the teeth 408. That is, the gap l between the lowest point on a tooth 408-T of the top portion 410 and the highest on a tooth 408-B of the bottom portion 412 can be defined as:

$$l = 2 w tan ( \frac{α}{2} )$$

wherein l is the gap size, w is the distance between the emission/focal point of the beams to the tooth gap, and α/2 represents half the illustrated angle α. It can be appreciated, however, that this lower bound is substantially smaller than most hazards, e.g., shopping cart bars and is only concerned with emission of the signal from the sensor 202 without disruption/reflections off teeth 408. Further, this bound does not account for a return signal, which must be maintained at a threshold power and/or signal to noise ratio (“SNR”), which may require the gap to be larger than this lower bound, as discussed below. The value of l also contains a maximum bound wherein the value of l plus the size of the teeth 408 hₜ should be equal to or smaller than the size of the hazard of concern. Due to the alternative spacing, the maximum gap size which prevents the hazard from colliding with the sensor 202 is l+hₜ rather than l which aids in ensuring the returning signals are detected, as discussed next in FIG. 5A.

The module 400 further includes a connection interface or frame 414, which includes one or more structural components configured to couple the top and bottom portions 410, 412 to each other and to a robot 102. The frame 414 may include one or more holes 406 (shown in FIG. 3C-D with bolts 316 affixed therein) configured to allow screws, bolts, etc. to pass therein to attach the structural components 414 of the module 400 to a robot 102. In the illustrated embodiment, two holes 406 are provided to give stability across multiple axis of rotation/translation, however the same stability may be achieved using, e.g., different shaped screw holes, latches, and other permanent or non-permanent attachment mechanisms. Preferably the attachment mechanisms are non-permanent to enable later maintenance of the robot 102, but this is not a requirement. The holes 406 may be located anywhere on the connection interface, such as on vertical brace plates 402 and horizontal brace plates 404 as needed based on the design of the robot 102 chassis. It is appreciated by those skilled in the art that the size, shape, and dimensions of the structural components of the frame 414 may be assembled to fit a particular model of robot 102, wherein the locations of the various holes 406 and brace plates 402, 404 is not intended to be limiting and should be configured to suit the body form of a given robot 102. The connection interface may further include one or more holes for cable routing between the sensor 202 and the controller 118 of the robot 102.

According to at least one non-limiting exemplary embodiment, the holes 406 of the connection interface may not align with any pre-drilled holes within a robot 102 body/chassis. Accordingly, in some instances, it may be required by a skilled technician to drill new holes in the robot 102 chassis at locations where the holes 406 bored in the structural components 414 of the module 400 can be aligned in order to couple the module 400 to the robot 102. Alternatively, the entire frame 414 could replace a previous frame, e.g., 308 shown in FIG. 3B above, rather than requiring drilling new holes 406.

FIG. 4B is a side view of a module 400 configured to be coupled to a sensor 202 and a robot 102, according to an exemplary embodiment. As shown, the dimension l of equation 1 above refers to the smallest gap formed by the bottom edge of teeth 408 of the top portion 410 and the top edge of teeth 408 of the bottom portion 412 of the module 400. The dimension l is measured from the distal edges of the teeth, farthest from the sensor 202 (as shown in FIG. 5B more clearly). As can be seen by the two perspective views in FIG. 4A-B, the teeth of the top and bottom portions 410, 412 do not contact the lens of the LiDAR sensor 202 and are at a distance w away from the LiDAR 202.

FIG. 5A is a front facing view of a LiDAR sensor 202 encased within a protective module 400, according to an exemplary embodiment. The LiDAR sensor 202 is configured to measure time of flight of emitted signals along a plane. The LiDAR sensor 202 further includes a lens 502 and a receiver element 504. The receiver element 504 may comprise a roughly planar disk (from the illustrated perspective) comprising of, e.g., an array of charged coupled devices (“CCD”) capable of receiving reflected signals in all directions or within the FOV of the sensor 202. In some embodiments, the receiver 504 shown may depict a mirror which focuses the returning light onto a smaller CCD array.

Receivers 504 are characterized by a surface area which is configured to collect a reflected signal. Collection of more reflected signal power (i.e., light) corresponds to a stronger signal with less noise, yielding more robust and reliable measurements. As mentioned previously, the gap l is configured such that no outgoing light is incident upon the teeth 408. However, in considering reflected light, the SNR must be above a threshold level to obtain a measurement. Further, in some instances, the power of the reflected signal must also be above a threshold value. Lastly, the power of the returning signal is dependent on the distance traveled by the signal, wherein distance to objects of interest must also be considered. For example, in some embodiments, a robot 102 may not need to know the locations of objects beyond 20 meters from itself. One skilled in the art would appreciate that the teeth 408 may occlude a portion of the detector 504 surface area, as seen by a target a distance from the sensor 202, thereby weakening the return signal.

Stated another way, the perspective view shown in FIG. 5 may be considered the view of a target looking back at the sensor 202. A beam 208 may be emitted from the LiDAR sensor 202 incident upon a location of the viewer of FIG. 5. From this illustrated perspective, the teeth 408 of the top and bottom portions 410, 412 occlude a portion of the solid angle subtended by the detector 504 thereby reducing the amount of reflected signal returned to the detector 502.

Light emitted from the sensor 202 may be highly directional (e.g., a spinning laser), but it is appreciated that the returning light is not directional and is a result of diffuse reflection off a surface. Accordingly, any given beam 208 emitted by the sensor 202 may be reflected back to the detector element 504 and be incident on the detector 504 at many locations, wherein the return signal power is integrated over the area of the detector 504.

The SNR required to obtain a measurement may be a fixed parameter intrinsic to the sensor 202 used. Often such parameter is stated by manufacturers of the sensors 202 and can be treated as a fixed, known value. To obtain sufficient SNR to operate the sensor 202, the parameters of the teeth 408 may be adjusted for a target of a certain distance. Ideally, the certain distance should correspond to the maximum distance of which the robot 102 must consider nearby objects to operate, but could be extended for safety concerns. The parameters of the teeth include the tooth width dₜ, the tooth gap d_{g}, the tooth 408 height hₜ, and the dimensions h and l. The tooth width dₜ, tooth height hₜ, and tooth gap d_{g} may all be adjusted without substantial constraint. For example, it may be determined that the teeth 408 must not occlude more than 10% of the detector element 504 area for a given target at a certain range, wherein there exist an infinite number of values of dₜ, hₜ, and d_{g} which satisfy this constraint.

However, some additional constraints are considered. Namely, value l must be less than the size of the hazard the module 400 is intending to prevent from colliding with the lens 502, which in turn may constrain w or the distance between the teeth 408 and the focal point of the sensor 202 (shown in FIG. 5B below). The value of l may be set based on the height/length of the sensor 202 lens 502 and increased to lower occlusion, or vice versa, while ensuring l to be smaller than the hazards. Under these constraints, the size and shape of the teeth 408 may be adjusted accordingly to prevent hazards from entering the teeth 408 without occluding the detector element 504 beyond a threshold amount. Lastly, the teeth 408 of the top portion 410 are misaligned with the teeth 408 of the bottom portion 412. Misaligning of the teeth allows for l to be used as the minimum gap to avoid hazards rather than h as objects would likely collide with both the top and bottom teeth 408, yielding less occlusion of the detector 504 area by permitting use of smaller teeth 408. Further, misalignment of the teeth 408 (408T, 408B) may yield a roughly uniform occlusion, rather than a periodic occlusion which may cause reflected signals of certain directionality to not reach the detector 504 with sufficient SNR to be considered a measurement. It is appreciated, however, that the less occlusion of the detector 504 by the teeth 408 yields more reliable measurements, thus the teeth 408 should occlude the minimum solid angle/area of the detector 504 while maintaining the value of h to be smaller than the hazards of concern (e.g., lower rack bars of shopping carts).

It is appreciated that there is no one solution for any given set of sensor intrinsic parameters for the values of dₜ, d_{g}, and hₜ which configure sufficient returning light to be received by the detector 504. Many solutions are contemplated without limitation. For example, the width dₜ of the teeth 408 may be increased while the spacing dₛ decrease without impacting the (i) safety of the lens 502 from collision with objects, and (ii) the occlusion of the detector element 504.

For the purpose of explanation, the size and shape of the teeth 408T, 408B are shown as uniform. However, one skilled in the art may appreciate that non-uniform teeth 408 may also be used on either the top, bottom or both portions of the module 400. Preferably, however, the teeth 408 should still be offset and extend into spacings formed by the teeth of the opposing side for the reasons discussed above. The size and shape of the teeth 408 shown herein and in other figures are configured such that the area of the detector 504 occluded is substantially uniform. The size and shape of the teeth 408 and their spacing d_{g} shown herein and in other figures (e.g., FIG. 3C-D) are configured such that the area of the detector 504 occluded is substantially uniform (e.g., 20% occlusion, ±5%) across the field of view of the sensor 202, which is horizontally across the area of the detector 504 in FIG. 5A. Stated another way, any vertical slice of the module 400 and receiver 504 depicted in FIG. 5A would include a substantially uniform subtended area or solid angle of the detector 504 of, for example, 20% occlusion ±5%. An advantage of uniform occlusion is that the return signal strength is not periodic or directionally biased which may impact the ability of the detector 504 to detect incoming return signals along certain angles.

One skilled in the art may appreciate that LiDAR lenses are rounded, wherein the view shown in FIG. 5A may represent an orthographic perspective of the detector 504 looking directly back to the detector 504 from all angles. In practice, occlusion from a singular point looking back at the detector 504 may not be uniform due to perspective.

To illustrate the constraints of the various parameters discussed in FIG. 5A from a different perspective, FIG. 5B illustrates the module 400 from a side view with only one row of top teeth 408T and bottom teeth 408B in view, according to an exemplary embodiment. As discussed above with reference to equation 1, the distance w is the distance between the focal point of the sensor 202 from which a beam 208 is emitted and the closest edge of the teeth 408. The value of l is measured between the distal edges of the teeth 408 farthest from the sensor 202 as shown. Using the specified beam variance (a fixed parameter of the sensor 202), the value of l may be increased by increasing w, or vice versa. The value of l must be large enough such that outgoing beams do not reflect off the teeth 408T or 408B (defined by equation 1 above). Further, the value l must also be smaller than the hazards from which the sensor 202 is to be protected from, wherein the teeth 408 height hₜ is a tunable parameter. Lastly, the value of l may be further configured to be large enough to ensure returning signals contain sufficient SNR to be detected as measurement for targets at a given distance, however it is appreciated that other parameters such as teeth spacing dₛ, teeth height hₜ, and teeth width dₜ may be adjusted independently from l to achieve the required SNR.

According to at least one non-limiting exemplary embodiment, the emissions from the LiDAR 202 may not follow the depicted model, wherein beams 208 deviate from the focal point or mirror 214. Rather, the beam 208 variance may be modeled as deviating from a focal point located on the outer lens of the sensor 202. Accordingly, in some instances, w may be measured from the outer lens of the sensor 202 rather than the center point or at the mirror 214.

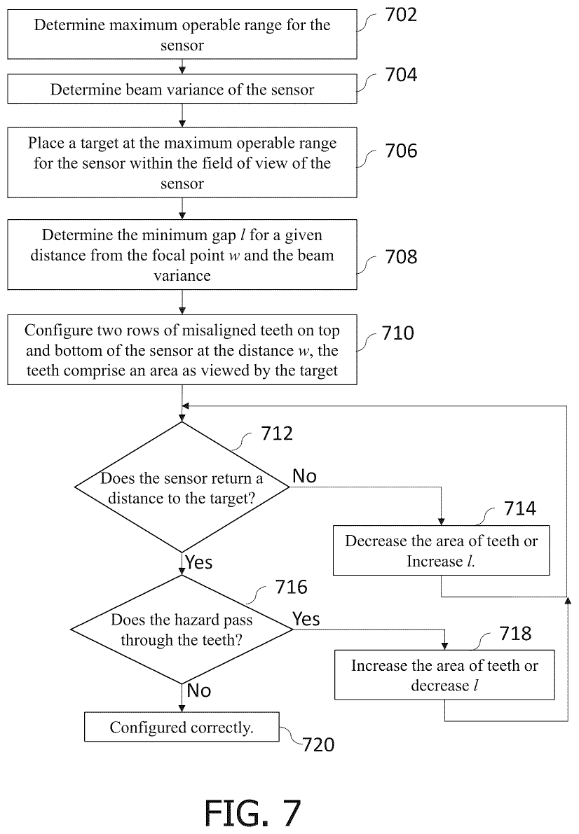

Stated another way, α, the SNR required to receive a measurement, and the size of the hazards are fixed parameters. Parameters l, w, h, hₜ, dₛ, dₜ, d_{g} and dₜ are all tunable parameters. The lower bound of l being based on beam divergence (α) and its distance w from the focal point following equation 1. The upper bound of l=h+hₜ would be dependent on the width of the hazards, wherein a larger h/l may cause such hazards to contact the sensor. Ideally, l is maximized to provide maximum SNR to the receiver 504, wherein the constraints on l may dictate the size, shape, and spacing of the teeth 408B, 408T. One skilled in the art may further appreciate that any of the listed tunable parameters may be constrained by other factors such as the body of the robot 102, attachment mechanisms therein, and other form specific factors. A process flow diagram 700 illustrating these design considerations is provided below in FIG. 7.

Advantageously, use of a module 400 to protect a LiDAR 202 from hazards the LiDAR 202 is designed to detect enables protection of the lens 502 from contact with objects (e.g., resulting in scratches and cracks) without inhibiting the ability of the sensor 202 to measure the environment. The use of teeth 408 provide multiple readily tunable parameters (e.g., dₜ, d_{g}, and hₜ) to enable one skilled in the art to design a protective module 400 to meet the intrinsic parameters of any sensor 202 without substantially occluding the detector element 504. Further, ensuring the teeth 408 do not extend into the angle α ensures no distance measurements from the sensor 202 to the teeth 408 are taken. Lastly, by alternating the teeth 408 in the top and bottom portions 410, 412 the gap h may be maximized, to be just smaller than a hazard of which the module 400 is designed to protect the sensor 202 from, yielding a strong and roughly uniform (i.e., non-directional) return signal than designs with aligned teeth 408.

FIG. 6 is a process flow diagram illustrating a method 600 for a human operator to couple a protective module 400 to an existing robot 102, according to an exemplary embodiment. Steps of method 600 may be executed by a skilled human technician using common tools available within the art, such as drills, screwdrivers, screws, wrenches, and the like.

Block 602 includes the operator powering off the robot 102.

Block 604 includes the operator detaching any protective coverings already in place. With reference to FIG. 3A-B depicting a floor cleaning robot, such protective coverings may include a front panel 304, a brush 306, and/or a frame 308 which currently supports the sensor 302 and/or other components. Other robots 102 configured to perform other tasks may have more, less, and/or different components to be decoupled at this stage in order to access the sensor 202 and/or its mount. Some mechanical couplers may also be removed at this stage, such as bolts 310 (shown in FIG. 3B) and/or 316 (shown in FIG. 3D). These components should be set aside until block 610.

One optional, recommended step is to cover the LiDAR sensor 202 with a temporary protective covering, such as a plastic film, to avoid scratches when performing the later steps of method 600. Often small scratches may impede the performance of the sensor 202 without being readily visible to the human eye.

Block 606 includes the operator placing a module 400 over the sensor 202. In some embodiments, the sensor 202 may remain coupled to the robot 102 (e.g., via mechanical attachment mechanisms and electronically via cables) as the module 400 is affixed to the robot 102 to ensure the sensor 202 position is not changed. The top and bottom portions 410, 412 of the module 400 form a U-shape, as can be seen in FIG. 4B, wherein the opening of the “U” faces inwards towards the robot 102. Accordingly, the module 400 may be translated onto the robot 102 over the sensor 202 by sliding the opening of the “U” shape over the sensor 202. With reference to FIG. 4B, the module 400 may be placed onto the robot 102 via translating it to the left over the sensor 202.

In other embodiments, the sensor 202 may be coupled to portions of the robot 102 which need to be removed in block 602 in order to access the sensor 202. For instance, with reference to FIG. 3B, the frame 308 may be coupled to the LiDAR sensor 302 which, in turn, couples both components to the robot 102 chassis. In this embodiment, the sensor 302 may be decoupled from the prior frame 308 and coupled to the new protective module 400 frame 414 (FIG. 4A). The sensor 202 and frame 414, once coupled to each other, may be re-affixed to the robot 102 in block 608.

Block 608 includes the operator securing a connection interface of the module 400 to the robot 102. The connection interface may include one or more mechanical attachment mechanisms, such as bolts 310 and/or 316 shown in FIG. 3A-D and/or holes 406 bored into brace plates 402, 404 shown in FIG. 4A. The brace plates 402, 404 are configured to be affixed to the chassis of the robot 102 via screws, bolts, or other (preferably non-permanent) mechanical attachment mechanisms, which may be screwed into pre-existing holes of the robot 102 chassis or into new holes drilled by the operator.

Block 610 includes the operator reattaching any protective coverings removed in block 604, which can be placed back onto the robot 102. For example, the front panel 304 and/or brush 306 may be reaffixed to the robot 102. It is appreciated, however, that the parts reaffixed or removed from the robot 102 may be specific to the particular make or model of robot, however, a protective module 400 may be used on any robot 102 regardless of its make or model, provided the connection interface is configured to the particular make or model. Accordingly, the teeth 408 of module 400 may be configured in a manner suitable for a particular sensor, whereas the connection interface may be configured to enable the protective module 400 to be used by any robot 102 comprising the particular sensor, thereby improving adaptability of the protective module 400 for use in a wide variety of robots 102 and sensors 202. For example, a module 400 may comprise portions 410 and 412 configured for a specific sensor, and a connection interface configured for a specific robot.

FIG. 7 is a process flow diagram illustrating a method 700 for configuring the various parameters of a module 400 for protecting a LiDAR sensor from one or more hazards, according to an exemplary embodiment. Steps of method 700 may be effectuated by a human designer for an existing robot, wherein the designer is tasked with determining reasonable values for the tunable parameters of the module 400 based on the robot 102 body, operational characteristics, and LiDAR sensor intrinsic parameters.

Block 702 includes the designer determining a maximum operable range for the LiDAR sensor. The maximum operable range may be different from the maximum range of the sensor, wherein the maximum operable range refers to the range at which the robot 102 must consider nearby objects when operating autonomously. For instance, a robot 102 may not need to concern itself with objects beyond 20 meters from itself in its normal operations in, e.g., path planning. Thus, despite the LiDAR sensor being potentially capable of measuring ranges beyond 20 meters, the module 400 is only required to facilitate measurements at 20 meters or less.

Block 704 includes the designer determining the beam variance (α). The beam variance is an intrinsic parameter of the sensor and may be provided by a manufacturer of the sensor. Alternatively it may be measured via a detector placed at a known distance and measuring the area of which the beams 208 are incident upon.

Block 706 includes the designer placing a target at the maximum operable range for the sensor within the FOV of the sensor. The target may comprise of any non-specular surface, preferably one of moderate reflectivity to simulate typical objects, which may comprise varying reflectivity. For instance, a broadband (in near infrared or infrared) reflective target would reflect additional light back to the sensor due to its high reflectivity, however in normal operation of the robot 102 such highly reflective objects may not always be present. If desired for safety concerns, the designer may utilize a poorly reflective surface, such as a black object, to simulate a worst case scenario.

Block 708 includes the designer determining a minimum gap l based on a distance w from the focal point of the sensor and the beam variance (α) in accordance with equation 1 above. The distance w may be additionally constrained by the size, shape and layout of the robot 102 chassis. For instance, with reference to FIG. 3 above, w may range from 1 to 3 inches, however one skilled in the art may appreciate that w could include other values for other robots 102. Preferably w is maintained to be as small as possible to reduce bulkiness added to the robot 102 and/or mechanical conflicts with other existing parts, cables, etc.

Block 710 includes the designer configuring two rows of misaligned teeth 408 on top 408T and bottom 408B of the sensor at the distance w from the focal point. The teeth comprise an area as viewed by the target (e.g., as shown in FIG. 5A). The solid angle occluded by these teeth, i.e., detector 504 area occluded, should be configured to minimally prevent the most hazards from passing through the teeth (i.e., l is equal to the size of the hazard) and impacting the sensor, while being small enough as to not occlude returning signals from the target at the maximum operable range. These teeth 408T, 408B and any connectors form a protective module 400. Preferably, the solid angle subtended by the teeth should be uniform, or substantially uniform (e.g., within 5-10%), across the field of view of the sensor (e.g., horizontally in FIG. 5A).

Block 712 includes the designer determining if the sensor can detect the target object at the maximum operable range. The designer may, for instance, active the sensor and read distance measurements therefrom, wherein the distances should be approximately the maximum operable range. In some instances, the outgoing beam may reflect off the teeth 408 if l is not configured properly yielding very short distance measurements.

If the sensor is unable to measure a distance to the target, the designer may move to block 714. If the sensor can measure a distance to the target, the designer may move to block 716. It is appreciated that a LiDAR 202 sensor may, even without any occlusion, fail to return range measurements. Accordingly, the designer may determine that the sensor 202 is able to measure the target if a sufficient number or percentage (e.g., 90% or more) of emitted beams 208 return a distance measurement.

Block 714 includes decreasing the area of the teeth or increasing l, if l is not currently maximized to be equal to the size of the hazards. Either or both options effectively reduce the occlusion of the detector 504, thereby improving SNR of the returning signal. Improving the SNR of the return signal may effectively increase the operable range of the sensor with the module 400 coupled thereto. Upon decreasing l and/or increasing the areas occluded by the teeth 408B and/or 408T, the designer may subsequently return to block 714 to verify if the sensor is able to measure the target with the modifications applied. In some instances, the spacing dₛ between any two teeth 408 may be increased to improve the SNR.

Block 716 includes the designer determining if the hazard can pass through the teeth 408T and 408B. The hazards from which the module 400 is designed to protect may be case specific based on environments within which the robots 102 operate and where the sensor 202 is disposed on the robot. For instance, a robot 102 operating in a supermarket using a LiDAR 302 as shown in FIG. 3A-B may be at risk of lower-racks of shopping carts colliding with the sensor, wherein the teeth 408T, 408B should prevent the lower-rack of the shopping cart (approximately h=l−hₜ=2 inches). As another example, the robot 102 depicted in FIG. 3A contains another planar LiDAR sensor disposed above the front cover 304 in front of the steering wheel which could also be at risk for damage. Such LiDAR sensor may also be configured with a toothed protective covering 400, wherein only the connection interface would be different from the ones depicted previously.

If the hazard can pass through the teeth 408, the designer may move to block 718 to decrease l and/or increase the area occluded by the teeth 408. Following such change, the designer returns to block 712 to ensure the sensor is still able to measure the target. In some cases, the tooth spacing, w, could be reduced (and the number of teeth 408 increased) if the hazard is small enough to fit in between the spaces of the teeth 408.

If the hazard is not able to pass through the teeth, the designer moves to block 720 and the module 400 is configured correctly.

Advantageously, method 700 enables designers to configure a protective module 400 to protect LiDAR sensors on a wide variety of robots 102 and/or LiDARs. Further, the protective module 400 is designed with modularity as an essential aspect as often it may be necessary to add additional protection to existing robots 102. It is appreciated that robots 102 operate in a wide variety of environments, each containing different hazards. Often specific hazards are anticipated, like shopping carts in a supermarket, however on occasion some hazards are not, such as a specific shelf or object unique to the environment which protrudes at a height just above the LiDAR and is undetectable by the LiDAR. By designing a modular protective covering 400 with a plurality of adjustable parameters, designers are capable of protecting LiDAR sensors on a wide variety of robots 102 operating in a wide variety of environments, as well as respond to new hazards as they are identified.

According to at least one non-limiting exemplary embodiment, the teeth 408 of the module 400 could be utilized as a calibration reference point. With reference to FIG. 2B(ii), teeth 408 proximate to the edges of the FOV β, i.e., lines 222, could be enlarged such that they are sensed by the sensor 202. Reducing or occluding the FOV proximate to the boundaries of the FOV using enlarged teeth would minimally impact the ability of the sensor 202 to detect nearby objects, however this impact on FOV range should be considered for narrow FOV LiDAR sensors. Preferably only one or two teeth 408 are utilized as such reference points. Since the value of w is known, the sensor 202 should expect to read a distance of w for all beams 208 incident upon the enlarged teeth. Failure to read such distance along the expected emission angle would indicate a calibration error. It is appreciated that this embodiment is only operable if the value of w is larger than the minimum range of the LiDAR sensor.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various exemplary embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations may be understood and effected by those skilled in the art in practicing the claimed disclosure from a study of the drawings, the disclosure and the appended claims.

It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open-ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least;” the term “such as” should be interpreted as “such as, without limitation:” the term “includes” should be interpreted as “includes but is not limited to;” the term “example” is used to provide exemplary instances of the item in discussion, not an exhaustive or limiting list thereof, and should be interpreted as “example, but without limitation;” adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

What is claimed is:

1. A module for a robot to prevent collisions, comprising:
a top portion comprising a first toothed edge comprising one or more top teeth;
a bottom portion comprising a second toothed edge comprising one or more bottom teeth;
wherein,
the top and bottom portions surround a sensor of the robot; and
the top teeth and the bottom teeth define a gap comprising a size wide enough to permit transmission and receipt of signals from the sensor to one or more objects of interest, the one or more objects of interest are not larger than a hazard.

2. The module of claim 1, wherein,
the sensor is a light detection and ranging sensor configured to measure along a plane; and
the teeth, at least in part, occlude a portion of a receiver element of the light detection and ranging sensor.

3. The module of claim 1, wherein,
the one or more teeth of the top and bottom portions form spacings; and
the teeth of the top portion protrude into the spacings of the bottom portion; and
the teeth of the bottom portion protrude into the spacings of the top portion.

4. The module of claim 2, wherein,
the one or more teeth of the top and bottom portions are of size and shape configured to not occlude more than a threshold value of either (i) a reflected signal to the sensor from the object of interest, or (ii) a subtended area of a detector of the light detection and ranging sensor from the perspective of the object of interest.

5. The module of claim 4, wherein,
the threshold is less than 20%.

6. The module of claim 4, wherein,
the subtended area of the detector is uniform across a field of view of the sensor.

7. The module of claim 1, further comprising:
one or more attachment mechanisms within a connection interface, the one or more attachment mechanisms are configured to allow the module to be coupled to the robot without manipulation of the sensor.

8. The module of claim 1, further comprising:
a connection interface configured to mechanically couple the module to the robot.

9. A robotic system, comprising:
a sensor coupled to the robotic system; and
a module configured to protect the sensor from a hazard, the module comprises:
a top portion comprising a first toothed edge comprising one or more top teeth;
a bottom portion comprising a second toothed edge comprising one or more bottom teeth;
wherein,
the top and bottom portions surround the sensor of the robotic system; and
the top teeth and the bottom teeth define a gap comprising a size wide enough to permit transmission and receipt of signals from the sensor to one or more objects of interest, the one or more objects of interest are not larger than the hazard.

10. The robotic system of claim 9, wherein,
the sensor is a light detection and ranging sensor configured to measure along a plane; and
the teeth, at least in part, occlude a portion of a receiver element of the light detection and ranging sensor.

11. The robotic system of claim 9, wherein,
the one or more teeth of the top and bottom portions form spacings; and
the teeth of the top portion protrude into the spacings of the bottom portion; and
the teeth of the bottom portion protrude into the spacings of the top portion.

12. The robotic system of claim 10, wherein,
the one or more teeth of the top and bottom portions are of size and shape configured to not occlude more than a threshold value of either (i) a reflected signal to the sensor from the object of interest, or (ii) a subtended area of a detector of the light detection and ranging sensor from the perspective of the object of interest.

13. The robotic system of claim 12, wherein,
the threshold is less than 20%.

14. The robotic system of claim 12, wherein,
the subtended area of the detector is uniform across a field of view of the sensor.

15. The robotic system of claim 9, wherein the module further comprises one or more attachment mechanisms within a connection interface, the one or more attachment mechanisms are configured to allow the module to be coupled to the robot without manipulation of the sensor.

16. The robotic system of claim 9, wherein the module further comprises a connection interface configured to mechanically couple the module to the robot.
